(19) United States
(12) Patent Application Publication
(10) Pub. No.: US 2015/0339439 A1
(43) Pub. Date: Nov. 26, 2015

(54) Method and System for Matching Probabilistic Identitypes on a Database

(71) Applicant: Mark W. Perlin, Pittsburgh, PA (US)

(72) Inventor: Mark W. Perlin, Pittsburgh, PA (US)

(21) Appl. No.: 14/229,321

(22) Filed: Mar. 28, 2014

(51) Int. Cl. G06F 19/28; G06F 19/22; G06F 19/24

(52) U.S. Cl. CPC G06F 19/28; G06F 19/24; G06F 19/22

(57) ABSTRACT

The present invention pertains to a process for matching biological items using a database. Specifically, the process comprises the steps of developing from genetic data a genotype for a biological item, together with a probability distribution over possible genotype allele pair values; (b) storing the item's genotype values and probability distribution on a computer database in a non-transitory memory; (c) storing a population probability distribution on the computer database; (d) specifying a match rule that defines a comparison between a first set of genotypes and a second set of genotypes stored on the database; (e) forming from the two sets of genotypes defined by the match rule, with a computer in communication with the database, pairs of genotypes that correspond to pairs of biological items; (f) partitioning the genotype pairs into disjoint groups that include all the pairs and do not overlap, ensuring that the number of pairs in each group remains bounded; (g) calculating, with a computer in communication with the database, for each genotype pair in the disjoint group, a match statistic that uses the genotype probability distributions; and (h) storing on the database a pair of genotypes, together with a match statistic that quantifies a strength of association between the corresponding pair of biological items. This probabilistic identitype database matching is useful for connecting objects to one another based on measuring their attributes. A probabilistic genotype database provides more accurate matching for DNA mixtures than does the FBI's prevalent CODIS database.

### FIELD OF THE INVENTION

The present invention pertains to a method for matching probabilistic identitypes on a database. More specifically, the present invention is related to comparing genotypes that reside on a database, and determining a match statistic based on genotype probabilities to assess a strength of association. The invention also pertains to a system related to this genotype matching.

### BACKGROUND OF THE INVENTION

Using DNA databases, biological evidence has the power to solve cold cases by connecting crime scenes with suspects through genetic comparisons. This power is evident in the Federal Bureau of Investigation (FBI)'s COmbined DNA Index System (CODIS) that regularly associates crimes with criminals. Other forensic databases, such the Automated Fingerprint Identification System (AFIS) can connect people and places through fingerprint patterns. There is a need in society, whether for commercial marketing, counter terrorism or military intelligence, to reliably associate distant objects or people through their observable features.

However, the functionality of databases such as CODIS is limited by their use of surface data features, rather than underlying identity types, or “identitypes”. The contributors to biological evidence have genotypes, not a list of allele peaks. (A “genotype” is an identitype derived from genetic data.) CODIS merely associates lists of alleles, and does not compute match statistics. As a result, it cannot handle uncertain mixture evidence well; most DNA mixture evidence is never uploaded to CODIS.

To obtain actual identitypes from evidence data, considerable computation is required to infer probability distributions over identitype values (Perlin, M. W. and A. Sinelnikov, 2009, incorporated by reference). To effectively connect identitypes from different scenes or objects, a probabilistic identitype database is needed that can perform valid statistical comparisons using a likelihood ratio (LR).

Cybergenetics TrueAllele® Casework technology is an advanced system for inferring reliable genotypes from DNA evidence. The validated TrueAllele computer separates DNA mixture data into component genotypes, with uncertainty represented through probability (Perlin, M. W., M. M. Legler, C. E. Spencer, J. L. Smith, W. P. Allan, J. L. Belrose and B. W. Duceman, 2011; and Perlin, M. W., J. L. Belrose and B. W. Duceman, 2013, incorporated by reference). Following genotype inference, these genotypes are compared with other genotypes to calculate a LR as a match statistic. Studies show that this approach is an effective way to preserve identification information.

The TrueAllele evidentiary approach—infer identitypes and match them—translates well to investigative databases for DNA, forensics and other areas. Computers can infer probabilistic identitypes from data, and store them on a database. An automated matching process can compare these identitypes, and calculate LRs. The LR value indicates the strength of association (or lack thereof) between two objects.

The present invention provides a general framework for matching probabilistic identitypes on a database.

### BRIEF SUMMARY OF THE INVENTION

The invention pertains to a method for matching probabilistic genotypes on a database comprising the steps of developing a genotype and probability distribution from genetic data for a biological item. Then there is the further step of storing the genotype along with its probability on a computer database. Then there is the further step of storing a population probability on the database. Then there is the further step of specifying a match rule compares two sets of genotypes stored on the database. Then there is the further step of forming pairs of genotypes that correspond to pairs of biological items. Then there is the further step of partitioning the genotype pairs into disjoint groups that include all the pairs, ensuring that the number of pairs remains bounded. Then there is the further step of calculating with a computer a match statistic for each pair in the group, using probability. Then there is the further step of storing on the database a genotype pair and a match statistic that quantifies a strength of association between biological items.

The invention also pertains to an apparatus for matching biological items comprising a computer database in a non-transitory memory which stores a genotype for a biological item together with a probability distribution over possible genotype allele pair values with respect to the genotype, a population probability distribution and a match rule that defines a comparison between a first set of genotypes and a second set of genotypes stored on the database. Then there is also a computer in communication with the database which forms from the first and second sets of genotypes defined by the match rule pairs of genotypes that correspond to pairs of biological items, partitions the genotype pairs into disjoint groups that include all the pairs, where the groups do not overlap, ensuring that the number of pairs in each group remains bounded, calculates for each genotype pair in the disjoint group a match statistic that uses the genotype probability distributions, and stores on the database a pair of genotypes, together with its match statistic that quantifies a strength of association between the corresponding pair of biological items.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a method for matching probabilistic genotypes on a database.

FIG. 2 shows an incremental matching of genotypes.

FIG. 3 shows a partitioning of pairs into disjoint groups, so that the number of pairs in a group remains bounded.

FIG. 4 shows a system for matching probabilistic genotypes on a database.

### DETAILED DESCRIPTION OF THE INVENTION

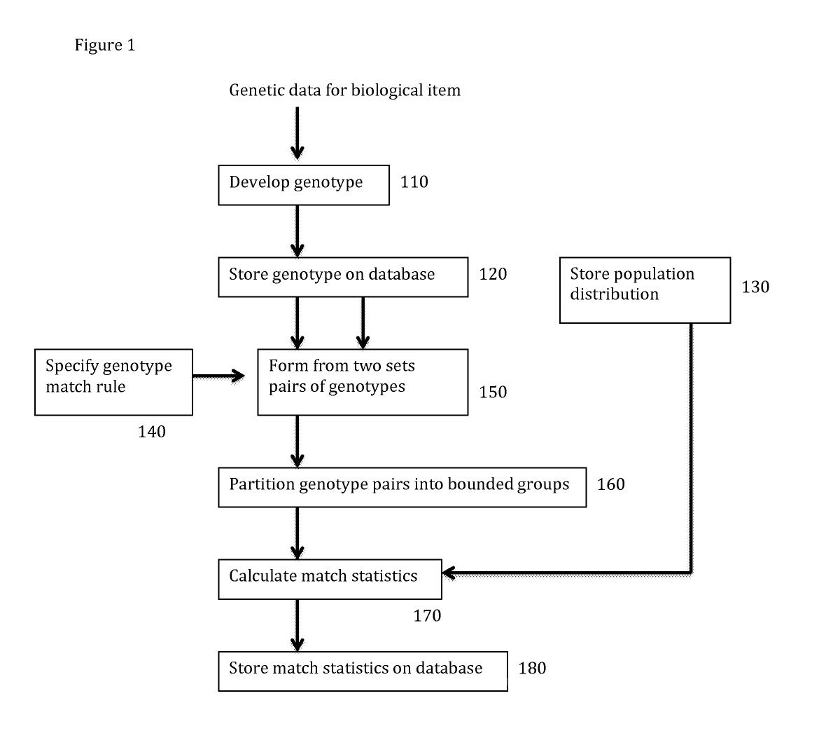

Referring now to the drawings wherein like reference numerals refer to similar or identical parts throughout the several views, and more specifically to FIG. 1 thereof, there is shown a method for matching biological items on a database comprising the steps of (a) developing from genetic data a genotype 110 for a biological item, together with a probability distribution over possible genotype allele pair values; (b) storing the item's genotype values and probability distribution on a computer database 120 in a non-transitory memory; (c) storing a population probability distribution 130 on the computer database; (d) specifying a match rule 140 that defines a comparison between a first set of genotypes and a second set of genotypes stored on the database; (e) forming from the two sets of genotypes defined by the match rule, with a computer in communication with the database, pairs of genotypes 150 that correspond to pairs of biological items; (f) partitioning the genotype pairs into disjoint groups 160 that include all the pairs and do not overlap, ensuring that the number of pairs in each group remains bounded; (g) calculating, with a computer in communication with the database, for each genotype pair in the disjoint group, a match statistic 170 that uses the genotype probability distributions; and (h) storing on the database a pair of genotypes, together with a match statistic 180 that quantifies a strength of association between the corresponding pair of biological items.

Probabilistic Identitype

An identitype is an underlying attribute of an object that can have more than one value. An identitype is useful for identifying and distinguishing between objects, based on their observed attributes. There may be uncertainty in these observations, and so an observed identitype has a probability distribution associated with its possible values. This distribution can be determined from data and a model as a posterior identitype probability through Bayesian update (Gelman, A., J. B. Carlin, H. S. Stern and D. Rubin, 1995, incorporated by reference). A probabilistic identitype is an identitype along with its probability distribution.

For example, in forensic DNA analysis, an STR genetic locus is an attribute of a genome. The value of the genotype (an identitype derived from genetic data) for an individual at the locus is a pair of alleles, measured as DNA fragment lengths. Uncertainty in STR data leads to a probability distribution at a locus over possible allele pairs.

A population identitype has a probability distribution that describes the chance of randomly selecting some specified identitype out of a population of objects. An evidence identitype of an object has a probability distribution based on observations related to measuring that object. A reference identitype has probability one for its identitype value.

For example, in DNA analysis an evidence genotype can arise from STR data obtained from a person's biological material, a DNA mixture of two or more people, or the genotypes of a person's relatives. A reference genotype usually comes from abundant DNA obtained from a known person, but can also be inferred from kinship data. A population genotype is determined by the alleles found in a convenience sample of individuals.

An identitype's probability distribution has a statistical divergence from the population distribution that can be measured as a Kullback-Leibler (KL) statistic (MacKay, D. J., 2003, incorporated by reference). The KL statistic is the expected value of the logarithm of the likelihood ratio. A low KL value (say, under 3) can be used to filter out uninformative or less informative identitypes, and keep them from entering onto an identitype database.

An object may have multiple attributes. A joint identitype is an identitype of these attributes. The probability distribution of a joint identitype is the joint probability distribution of its attributes. For example, an STR genotype is a joint identitype having multiple genetic loci, not just one locus.

Observations may arise from data derived from a mixture of objects. A contributor identitype is the identitype of one of the objects contributing to the data. For example, a DNA mixture has multiple contributors measured at multiple loci, so each contributor at each locus has an identitype with a definite value. Based on observed data, this identitype can be inferred as a probability distribution.

The above definitions and examples characterize the sort of identitypes and joint identitypes that can be stored on a computer, along with their probability distributions, as specified in claim 1 steps (a), (b) and (c).

Conjunctive Match

Two objects match when their attributes are the same. An extent of match can be determined numerically. In order to assess the extent of match between two identitypes, a pair of identitypes has to be examined together. Then the identitype values, and the probability distributions over these values, can be compared.

For example, an exact match between two genotypes (as joint identitypes) occurs precisely when their allele pair values are the same at every locus (as single identitypes). This is a conjunctive match, which requires that all the single identitypes match exactly. The extent of match between two genotypes can be assessed using a match statistic. With independence between the loci, single locus statistics can be multiplied together to calculate a joint statistic.

When considering many identitype objects, the task is to compare one subset of identitype with another subset of identitype. These identitype subsets may be the same (e.g., when comparing evidence identitypes from many scenes with each other, or comparing reference identitypes from many individuals with each other) or different (e.g., when comparing evidence identitypes from many scenes with reference identitypes from many individuals). This comparison is done on the cross product of the two sets, where each element in the cross product is a pair of identitypes.

A match rule defines the two identitype subsets that are to be compared with one another. An alpha rule specifies attributes of one identitype (e.g., name, class, value, role). A beta rule specifies attributes that are common to a pair of identitypes (e.g., a condition that both identitypes belong to the same case). A database may have more than one match rule.

Once identitypes have been stored on a database, in order to make a (logical conjunctive or numerical statistical) match comparison between two identitypes, a match rule will form pairs of identitypes from the identitypes stored on the database, as specified in claim 1 steps (d) and (e).

Incremental Match

Match systems continually make comparisons on new identitypes as they are produced. Once two older identitype objects specified by a match rule have already been compared, there is no need to redundantly repeat their previous match comparison calculation. Instead, old match results can be preserved, with new matches computed only for new identitypes that have appeared since the last match operation.

Incremental conjunctive match is a long established computational procedure (Forgy, C. L., 1982, incorporated by reference). The approach entails separating old identitypes (present before the last match operation) and new identitypes (appearing after the last match operation). Non-incremental match would naively compare all (old+new) identitypes with all (old+new) identitypes, repeatedly incurring the high computational cost of comparing old vs. old every time.

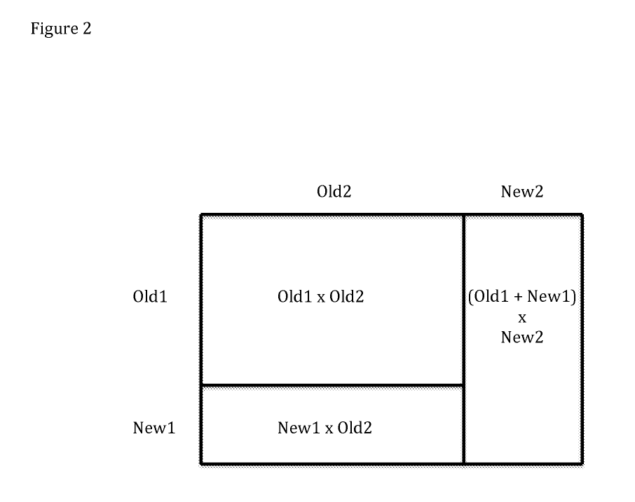

Incremental match does not compare old identitypes with old identitypes, since that comparison has already been computed and stored on the database, referring to FIG. 2. Instead, it compares new identitypes with old identitypes, reclassifies those new identitypes as old identitypes, and then compares old identitypes with new identitypes. When there are far more old identitypes than new, this incremental update greatly reduces computational cost.

Partitioned Match

When executing batch comparisons of identitype pairs with computational limitations (e.g., space or time), it can be helpful to partition a large cross product of identitype pairs into smaller cross product subsets. In particular, the incremental computation can be constrained by partitioning the pairs into disjoint groups, so that the number of pairs in a group is bounded, as stipulated in claim 1 step (f). The bound number N is chosen to ensure that computational limitations are not exceeded.

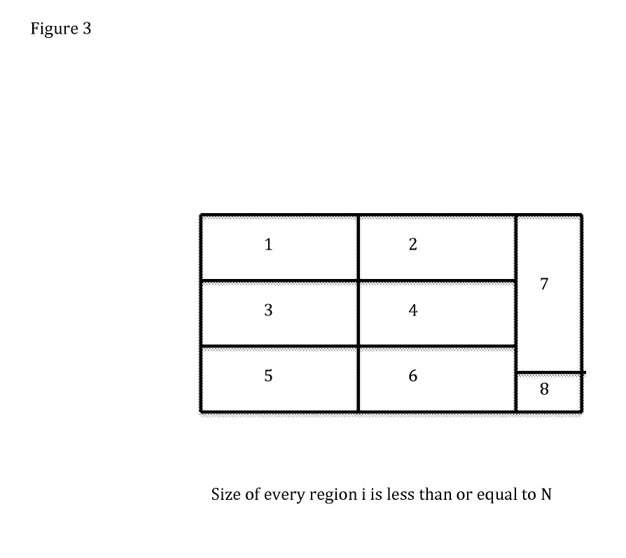

A cross product of two sets can be represented geometrically as a rectangle. Such rectangular representations appear in both non-incremental and incremental match computation. The area of the rectangle corresponds to the number of identitype pairs that have to be assessed. By partitioning the rectangle into smaller rectangles, each bounded by N, the claimed invention step 1(f) is accomplished. This partitioning can be done by a repeated area subdivision, referring to FIG. 3, using a variant of the Euclidean algorithm.

Let a1 be the number of identitypes in a first identitype set, and a2 the number of identitypes in a second identitype set. We can then subdivide the identitype set sizes a1 and a2 as:

a1=i1*N+r1,r1<N

a2=i2*N+r2,r2<N

N=j1*r2+x1,x1<r2

N=j2*r1+x2,x2<r1

r1=k1*j1+s1,s1<j1

r2=k2*j2+s2,s2<j2

The number of identitype pair comparisons a1*a2 in the rectangle can then be decomposed into (at most) four main blocks, with r1, r2<N as:

$$\begin{matrix}a 1 * a 2 = ( a 1 ) * ( i 2 * N + r 2 ) \\ = ( a 1 * i 2 ) * [ 1 * N ] + ( a 1 * r 2 ) \\ = ( a 1 * i 2 ) * [ 1 * N ] + ( i 1 * r 2 ) * [ N * 1 ] + ( r 1 * r 2 )\end{matrix}$$

where each term is the number of block replicates (indicated in parentheses) times the block size (indicated in square brackets). In the last line of the above expression, the first two terms each have block size N. The final term can be written for row blocks as:

$$\begin{matrix}r 1 * r 2 = ( k 1 * j 1 + s 1 ) * r 2 \\ = ( k 1 * 1 ) * [ j 1 * r 2 ] + ( 1 * 1 ) * [ s 1 * r 2 ]\end{matrix}$$

or, alternatively for column blocks, as:

$$\begin{matrix}r 1 * r 2 = r 1 * ( k 2 * j 2 + s 2 ) \\ = ( 1 * k 2 ) * [ r 1 * j 2 ] + ( 1 * 1 ) * [ r 1 * s 2 ]\end{matrix}$$

The block sizes j1*r2, s1*r2, r1*j2 and r1*s2 are all bounded above by N. Therefore, every block in the partition has an area bounded above by N. Thus the number of pairs in each group does not exceed bound N, which provides enablement for Claim step 1(f).

Linear Partitioning

In an alternative preferred embodiment, the Claim step 1(f) partitioning is performed linearly in one dimension on genotype pairs, rather than done using two or more dimensions.

A cross product of two sets can be represented geometrically as a rectangle. The element pairs in this rectangle can be traversed raster-style, reading off the elements from left-to-right in the first row, then the second row, and so on until the last row is completely read. (Alternative linear traversals can be done by column instead of row, or by starting in different row or column locations.) This row-by-row traversal can be grouped into segments of size N (or less). By partitioning the rectangle into line segment groups, each bounded by N, the claimed invention step 1(f) is accomplished.

Let a1 be the number of identitypes in a first identitype set, and a2 the number of identitypes in a second identitype set. Each pair of identitypes in the cross product then has a unique order pair of indices (i1, i2), where 1<=i1<=a1, and 1<=i2<=a2. These indices can be arranged as a table in lexigraphical order, with a1 rows and a2 columns:

(1, 1), (1, 2), . . . , (1, a2),

(2, 1), (2, 2), . . . , (2, a2),

. . .

(a1, 1), (a1, 2), . . . , (a1, a2).

Note that by the division algorithm, a1*a2=q*N+r, where q is a quotient and r is a remainder less than N.

Using this ordering, the first N pairs form a first linear group. Then the second N pairs in the list form a second linear group. This partitioning process continues to form q linear groups of size N, with possibly an additional group of size r. These q or q+1 groups are all bounded above by N. Thus the number of pairs in each linear group does not exceed bound N, which provides enablement for Claim step 1(f).

Match Statistic

A match statistic between identitype pairs can help determine their strength of association. Current identitype databases, such as the FBI's COmbined DNA Index System (CODIS) make associations, but do not calculate match statistics. A standard match statistic is the likelihood ratio (LR), which measures the evidential support for a hypothesis, relative to its alternative (Good, I. J., 1950, incorporated by reference). The LR can be written as

$$LR = \frac{Pr \{ {d}_{1} , {d}_{2} \vert H \}}{Pr \{ {d}_{1} , {d}_{2} \vert ∼ H \}}$$

where “Pr” denotes probability, d₁ is the data underlying the first identitype, d₂ is the data underlying the second identitype, H is the hypothesis, and ˜H is the alternative hypothesis (Aitken, C. G. and F. Taroni, 2004, incorporated by reference). In forensic science, a typical hypothesis is that an individual contributed their DNA to biological evidence. More generally, the hypothesis is that two objects share a common source.

Let X be the random variable (RV) of the first identitype, with posterior probability distribution f(x)=Pr(X=x|d₁), and Y the RV of the second identitype, with posterior probability distribution g(x)=Pr(Y=x|d₂). Suppose that Z is the RV of a population identitype, with prior probability distribution h(x)=Pr(Z=x). Then the likelihood ratio can be calculated as the sum over all identitype values x in the value set V of the triple probability product

$$LR = {\sum }_{x ∈ V} \frac{f ( x ) \cdot g ( x )}{h ( x )}$$

(Perlin, M. W., 2010, incorporated by reference). With a continuous random variable, the sum is replaced by an integral.

A less preferred embodiment for calculating the LR involves more computationally expensive ratios of sums of likelihoods, such as

$$LR = \frac{{\sum }_{x ∈ V} {λ}_{X} ( x ) \cdot {λ}_{Y} ( x ) \cdot h ( x )}{{\sum }_{x ∈ V} {λ}_{X} ( x ) \cdot h ( x ) {\sum }_{x ∈ V} {λ}_{Y} ( x ) \cdot h ( x )}$$

where λ_{X} (x) is the likelihood function Pr(d₁|X=x, . . . ) for RV X, and λ_{Y} (x) is the likelihood function Pr(d₂|Y=x, . . . ) for RV Y. By computing the denominator as a double sum, this embodiment can account for population substructure.

When comparing inferred identitype X and Y, the posterior probability distributions f(x) and g(x) are known. Moreover, the random identitype Z's prior probability distribution h(x) is known as well. Therefore, a computer can readily calculate the LR as a match statistic for each pair in the group, using the probability distributions, as in Claim step 1(g). On a database, this calculation can be done across a group of identitype pairs by applying the LR formula to the probability distributions of each identitype in the pair.

A positive log(LR) provides support for the hypothesis of a common source for the inferred identitypes, while a negative log(LR) provides support for the alternative hypothesis that the sources are different. A log(LR) of around zero indicates that the data may be uninformative for the hypothesis.

To calculate the LR for a joint identitype, the log(LR) values of each independent identitype are added together. For example, with DNA data, the log(LR) values at each independent STR locus are summed up to obtain the joint log(LR) value.

Relational Database

Relational databases are a persistent and distributed way to organize structured data on a computer (Date, C. J., 2004, incorporated by reference). Using Structured Query Language (SQL) statements, table records can be added through INSERT, removed through DELETE and modified through UPDATE. SQL queries are declaration, making set-relation statements that a database engine can translate into lower level computer instructions. Commonly used relational databases are the commercial product Oracle and the open source PostgreSQL.

Identitypes and their probability distributions can be stored in database tables. Match rules can also be stored in tables. A computer can invoke a comparison of identitype pairs that includes the new identitype records that have not been previously matched. Having the database query organize the identitype pairs into groups of bounded size, as in claim 1 step (f), helps ensure that the database does not expend inordinate time or space during its match calculation, or exceed those resources.

A SQL query can calculate a likelihood ratio for sets of identitypes pairs in a group, referencing the identitype probability distributions in database tables. For example, claim 1 step (g) can compare identitypes X and Y (relative to population identitype Z) using the SQL code

select sum(f.prob*g.prob/h.prob)

where appropriate equality constraints are applied to table columns of identitypes X, Y and Z, and table column ‘prob’ gives probability values for respective distributions f, g and h.

Match Computation

The match statistic can be calculated directly on the database computer using SQL code, as described above. In a less preferred embodiment, the match calculation can be done on a different computer by downloading the probability distributions, performing the LR calculations, and then uploading the results to a table on the database.

For process automation and flexibility, the SQL code for the match comparison and calculation can be assembled dynamically by another computer process. Some of this code can be stored in a match rule's database table. For example, alpha and beta rules that determine the identitype subsets for comparison can be expressed as SQL code text in a table record. With conjunctive match, an identitype or identitype pair would have to satisfy all of the specified alpha or beta tests. The WHERE clause in SQL can comprise a set of AND conditions that lends itself naturally to conjunctive match.

Parallel Operation

In Claim step 1(f), the invention partitions the match comparison and statistical calculations into identitype pair groups of bounded size. This partition forms disjoint groups that cover all the identitype pairs. Since these subsets are mutually exclusive and exhaustively cover the entire set, they can be processed independently. In particular, the groups can be parceled out to different computer processors. This division of computing labor enables parallelization of the match computation. Parallel operation enjoys advantages of greater speed and robustness.

In one embodiment of the parallel approach, the database maintains a table of partitioned identitype pair groups. Each match rectangle record provides group information, including the left and right endpoints for the first identitype, the endpoints for the second identitype, and the alpha and beta components of the match rule. A match execution processor takes exclusive ownership of a table record, and then executes the match procedure for all identitype pairs in the specified group. When done, the processor marks or deletes the group record, signaling that the group's matching has successfully completed.

Database Storage

After calculating a match statistic on a (possibly joint) identitype pair, the pair can be retained on the database along with its statistic. Alternatively, the pair can be discarded in order to save database space, if the statistic is not sufficient to warrant retention. A match rule can provide an optional log(LR) cutoff value for this purpose; cutoffs of 0 or 3 are typical, corresponding to LR=1 or LR=1000, respectively. The database can then store a identitype pair, as described in claim 1 step (h).

In the most preferred embodiment, the database resides on a database server computer that stores the identitypes, performs the match calculations, and records the matched identitype pairs and their match statistics (when sufficiently large). One or more logically separate inference server computers perform identitype inference from evidence data, and upload inferred identitype and their probability distributions directly to the database server. A separate client computer is used for people to interface with the server computers.

Match Retrieval

Matches between (possibly joint) identitypes can be retrieved from the database using SQL queries. In the most preferred embodiment, a client computer accesses the database server, and issues SQL queries to download identitype pair match information from the database. The client access to the database can be made secure (e.g., password protected).

The client computer can organize the retrieved (joint) identitype pair information. A user can sort and select match results based on LR match statistics, source or role of evidence, identitype attributes, sample naming, date of identitype inference, and other categorizations. When sample names contain case and item names, a user can examine retrieved database matches based on the case, sample item name, inferred identitype or specific identitype inferences.

Matches between identitype pairs can be shown in tables, where each row corresponds to a match result. A graphical user interface can show a set of retrieved matches, where the x-axis corresponds to one set of identitype, and the y-axis to another set of identitypes. The log(LR) extent of match between two identitype subsets can then be displayed as a two dimensional image within these x and y axes, using color, intensity or numbers. Claim 7 describes retrieving from the database a strength of association to determine a potential match between a pair of objects.

Match Notification

The database can notify a user about a match result. The user can manually pull the match information using a graphical user interface (GUI) as described above. The computer can also automatically push the match outcome to a user, sending an email or text message. To do this, the database maintains a table of users that includes contact information, and records which users are interested in being notified about particular cases. When a noteworthy match event occurs (e.g., a comparison of interest having a LR exceeding some threshold), the computer sends a message to the user.

A mobile device application can provide similar match retrieval functionality for accessing database matches, though perhaps on a smaller display screen. From the client app, a user can access the database to pull match information from the computer. Also, the database can push a match result to the app, providing the user with more interactive access to the match results than just a plain message, with query functionality similar to a desktop client application.

Laboratory Workflow

Using a probabilistic genotyping database, a novel workflow for a DNA laboratory can largely eliminate the tedious up-front manual inspection, review and analysis of STR data. First, the lab generates STR data as electronic files. Then, instead of visually examining the data, the STR data is analyzed by a reliable computer system to produce probabilistic genotypes. These genotypes may arise from low-level STR data or by separating DNA mixtures. Regardless, the genotypes (and their probabilities) are all uploaded to a matching genotype database with minimal human involvement.

The database continuously compares genotypes (both within and between cases), calculating match statistics for every genotype pair. Forensic analysts then focus their attention on positive (or negative) match associations of interest, as LR values determined automatically by the database. Harvesting these interesting genotype matches within a case highlights the connections between DNA evidence and persons of interest. Harvesting genotype matches between cases identifies potential serial criminal activity.

In this novel workflow, the human work begins only at the end of an automated genotype and match process, after the match information is already known. Forensic analysts need not laboriously develop this information—the probabilistic genotype database provides it to them before they ever start their data analysis.

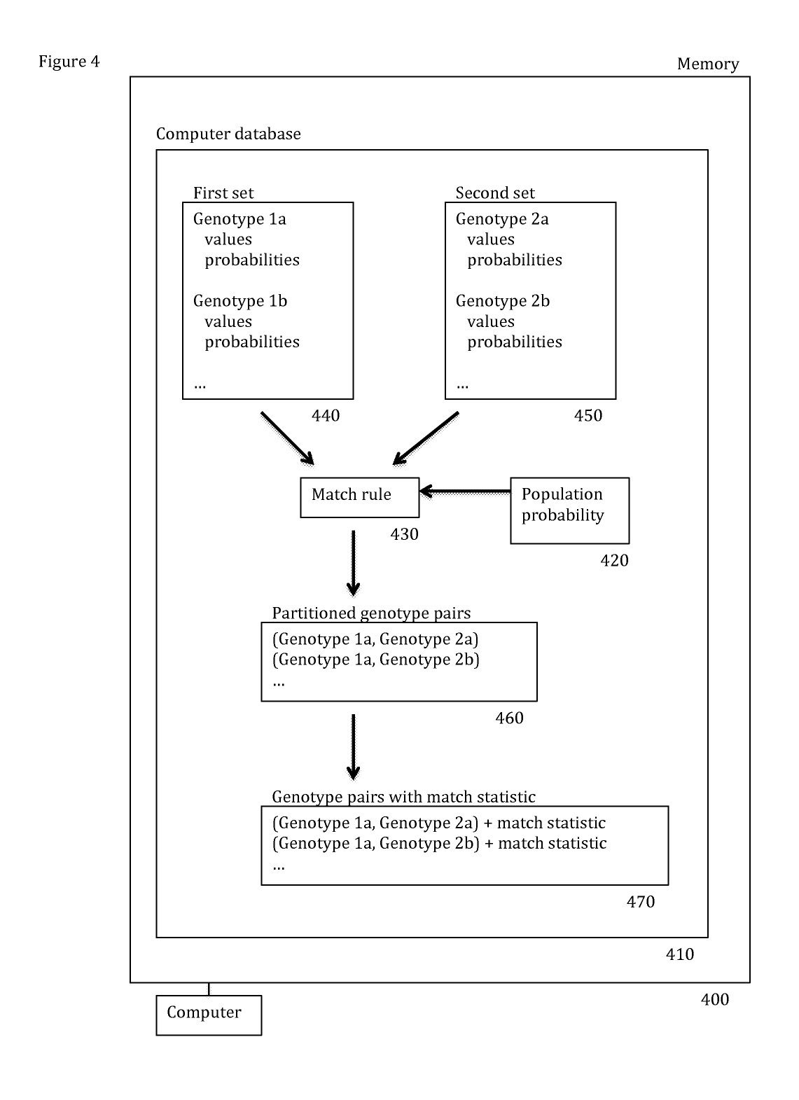

Referring to FIG. 4, there is shown a system for matching biological items comprising a computer database 410 in a non-transitory memory 400 which stores a genotype for a biological item together with a probability distribution over possible genotype allele pair values with respect to the genotype.

Furthermore, there is a population probability distribution 420 and a match rule 430 that defines a comparison between a first set of genotypes 440 and a second set of genotypes 450 stored on the database.

Furthermore, there is a computer in communication with the database 410 which forms from the first and second sets of genotypes defined by the match rule 430 pairs of genotypes that correspond to pairs of biological items, partitions the genotype pairs into disjoint groups 460 that include all the pairs, where the groups do not overlap, ensuring that the number of pairs in each group remains bounded.

Furthermore, the system calculates for each genotype pair in the disjoint group a match statistic that uses the genotype probability distributions, and stores on the database a pair of genotypes, together with its match statistic 470 that quantifies a strength of association between the corresponding pair of biological items.

DNA Applications

Probabilistic identitype databases with statistical matching capability have many applications for connecting objects with one another through their identitypes.

Such databases are useful in DNA analysis, where genetic data can be obtained from a biological item, a genotype can be developed from the genetic data, and this genotype together with a probabilistic distribution can be stored on the database. By calculating a match statistic for a genotype pair and storing the pair and the statistic on the database, the database can quantify a strength of association between the corresponding pair of biological items.

For solving cold cases, the database can match a crime scene to a suspect (e.g., a convicted offender). This is done using a match rule that compares a first set of evidence genotypes with a second set of reference genotypes. Each evidence genotype in the first set corresponds to a biological item collected from a crime scene. Each reference genotype in the second set corresponds to an individual who can be considered to be a suspect in a crime. When there is a match statistic greater than 1 (or some other number) between an evidence genotype and a reference genotype, the database can associate the corresponding crime scene item and the individual.

For detecting serial crime, the database can match a first crime scene to a second crime scene. This is done using a match rule that compares a first set of evidence genotypes with a second set of evidence genotypes. Each evidence genotype in the first set corresponds to a biological item collected from a first crime scene. Each evidence genotype in the second set corresponds to a biological item collected from a second crime scene. When there is a match statistic greater than 1 (or some other number) between the two evidence genotypes, the database can associate the corresponding crime scenes through the genotypes of their biological items.

The database can be used for identification purposes, such as immigration, comparing individuals to individuals. This is done using a match rule that compares a first set of reference genotypes with a second set of reference genotypes. Each reference genotype in the first set corresponds to an individual in a population of people. Each reference genotype in the second set corresponds to an individual in a population of people. When there is a match statistic greater than 1 (or some other number) between a first reference genotype and a second reference genotype, the database can associate the corresponding individuals, possibly as being the same person.

Probabilistic genotypes can preserve more identification information from DNA mixtures or low-template DNA. Therefore a genotype database works better than older database methods for connecting biological evidence or solving crimes through genetic data. A genotype database summarizes the DNA identification content of a biological item through its genotype probability distribution. When comparing accurately inferred genotype probabilities, all biological items can be uploaded onto the genotype database, without undue concern about a high rate of false positive DNA hits. This ability of genotype databases to upload all DNA mixtures or low-template DNA samples provides a significant improvement over current allele-based databases (such as CODIS) that restrict upload to biological items having simpler genetic data.

Genotype databases can represent uncertain genotypes through probability. Therefore, all kinds of genotypes can be uploaded, stored and compared to produce a strength of association. In one preferred embodiment, kinship genotypes are stored on the database. If a person's genotype is not known directly through genetic data, their genotype can be inferred indirectly from the genotypes of their relatives. Having more relative genotypes will generally sharpen the person's inferred genotype probability distribution. A kinship genotype can be used as a proxy on the database in place a known genotype. This use of kinship genotype probability distributions improves over less informative allele-based databases (such as CODIS) that discard considerable identification information.

In mass disasters, a probabilistic genotype database can store genotypes from different classes of biological evidence, and compare these genotypes to calculate DNA match statistics (Perlin, M. W., 2007, incorporated by reference). The biological evidence classes include (a) victim remains, which may be damaged or at low levels, (b) personal effects from missing persons such as clothing or toothbrushes, which are often mixtures, and (c) kinship genotypes of missing persons that are mathematically derived from family members.

Disaster victim identification (DVI) is then done using a match rule that compares a first set of victim remains genotypes with a second set of missing person genotypes developed from personal effects and/or kinship genotypes. Each victim remains genotype in the first set corresponds to a biological item collected from a disaster scene. Each missing person genotype in the second set corresponds to a biological item collected from personal effects or relatives. When there is a match statistic greater than 1 (or some other number) between a victim remains genotype and a missing person genotype, the database can associate the victim remains with a missing person through the genotypes of their biological items. By using more of the data to represent and compare biological items, a genotype database can better perform DVI.

Familial search is a DNA database approach for connecting crime scene evidence to relatives of perpetrators in order to generate investigative leads (Bieber, F. R., C. H. Brenner and D. Lazer, 2006, incorporated by reference). Starting from a known offender genotype, a computer can generate parent, child and sibling genotypes (as probability distributions), and store these kinship genotypes in advance on a probabilistic genotype database. A genotype database can compare these kinship genotypes with evidence genotypes (whether from single source or mixture DNA). This database comparison calculates a match statistic between a kinship genotype and an evidence genotype that associates a relative of a perpetrator with a biological evidence item.

Genotype databases can be used to help prevent crime. By associating crime scenes with criminals through genotypes, criminals can be apprehended before they commit more crimes and victimize more people. Older allele-based DNA databases (such as CODIS) make less use of genetic data, and so restrict the upload of biological evidence. Moreover, such older databases do not calculate DNA match statistics between biological items. By permitting the upload of genotypes from all biological items, and calculating match statistics between them, the current invention enables more genetic associations to be made, thereby increasing DNA database efficacy in identifying criminals and preventing their further crimes. A genotype database can better reduce preventable victimization from crime, and better use DNA data to create a safer society.

Capabilities of the Invention

The invention includes a method for matching biological items using a database, comprising the steps of developing from genetic data a genotype for a biological item, together with a probability distribution over possible genotype allele pair values. Then there is the further step of storing the item's genotype values and probability distribution on a computer database in a non-transitory memory. Then there is the further step of storing a population probability distribution on the computer database. Then there is the further step of specifying a match rule that defines a comparison between a first set of genotypes and a second set of genotypes stored on the database. Then there is the further step of forming from the two sets of genotypes defined by the match rule, with a computer in communication with the database, pairs of genotypes that correspond to pairs of biological items. Then there is the further step of partitioning the genotype pairs into disjoint groups that include all the pairs and do not overlap, ensuring that the number of pairs in each group remains bounded. Then there is the further step of calculating, with a computer in communication with the database, for each genotype pair in the disjoint group, a match statistic that uses the genotype probability distributions. Then there is the further step of storing on the database a pair of genotypes, together with a match statistic that quantifies a strength of association between the corresponding pair of biological items.

Other Applications

The invention described herein for matching biological items using a database, comprises the steps of (a) developing from genetic data a genotype for a biological item, together with a probability distribution over possible genotype allele pair values; (b) storing the item's genotype values and probability distribution on a computer database in a non-transitory memory; (c) storing a population probability distribution on the computer database; (d) specifying a match rule that defines a comparison between a first set of genotypes and a second set of genotypes stored on the database; (e) forming from the two sets of genotypes defined by the match rule, with a computer in communication with the database, pairs of genotypes that correspond to pairs of biological items; (f) partitioning the genotype pairs into disjoint groups that include all the pairs and do not overlap, ensuring that the number of pairs in each group remains bounded; (g) calculating, with a computer in communication with the database, for each genotype pair in the disjoint group, a match statistic that uses the genotype probability distributions; and (h) storing on the database a pair of genotypes, together with a match statistic that quantifies a strength of association between the corresponding pair of biological items.

The invention is not limited in any way to DNA matching. In one preferred embodiment for a matching database, once identitypes (or sets of identitypes) have been determined as probability distributions for a certain kind of object or activity, they can be represented and compared in an identitype database. If the identitypes in a joint type are independent of each other, then log(LR) information can be added together. Otherwise, an LR can be calculated using multidimensional values.

Moreover, consider the spatial distribution of a person's location throughout the day, as determined by sensing their mobile phone. That 2-D plot can be viewed as a two-dimensional probability distribution. Thus, each mobile phone has its own identitype signature, represented with probability. These signatures can be uploaded to an identitype database, and then automatically compared (relative to average spatial behavior for different subpopulation identitypes). LR match results can be used detect people and their cohorts through spatial location.

In another preferred embodiment, a complex data set can be reduced through multidimensional scaling (MDS) to lower dimensionality. Reduction to two dimensions is common because of human visual processing. Sampling multiple times from an ensemble, and reducing the data with MDS, can produce a frequency plot for that ensemble. For example, Next Generation Sequencing (NGS) of a commonly occurring mutable bacterial gene will provide a high dimensional data point for each bacterium in a particular soil sample; in aggregate, a probability distribution is obtained for the soil type. Comparing the MDS-reduced types of different soil samples on a probabilistic identitype database to produce LR match statistics can identify soil samples that may share a common origin.

### Examples

This section illustrates the operation of the invention, proceeding through the steps of claim 1 using different kinds of genotypes. Deoxyribonucleic acid (DNA) mixtures are used in many of the illustrative examples, showing how genotype probabilities are represented and compared.

### 1. Single Source DNA Versus Reference

The simplest case of genotype comparison is when both genotypes have definite probability distributions, where at each genetic locus all the probability resides on just one allele pair possibility.

A single source DNA evidence item can be collected at a crime scene from a blood stain, skin, hair or cigarette butt. A single source DNA reference items can be collected from an individual as a buccal swab or blood sample. Genetic data is generated from biological evidence, as described next.

Claim 1, step (a) developing from genetic data a genotype for a biological item, together with a probability distribution over possible genotype allele pair values;

One preferred embodiment of the invention for forensic identification purposes uses short tandem repeat (STR) loci as genetic markers (Butler, J. M., 2005, incorporated by reference). The alleles at an STR locus are comprised of varying lengths of DNA sequence, where a short DNA sequence of 4 or 5 base pairs is repeated in tandem, say 10 to 30 times. An individual's genotype at a locus is a pair of alleles. With many alleles, and a quadratic number of allele pairs, there is considerable genetic variation at each locus for distinguishing between people.

A laboratory obtains a biological item, and extracts DNA from the item. Amplifying the DNA in a polymerase chain reaction (PCR) experiment purifies many STR allele copies into fluorescently labeled amplicons. A typical STR multiplex kit will amplify 10 to 20 loci simultaneously. The labeled alleles are optically detected during capillary electrophoresis on a genetic analyzer, separating DNA fragments by their size. The resulting data at each locus show a train of peaks, with DNA size on the x-axis and DNA quantity on the y-axis. The genetic analyzer records the data as electronic data files that contain peak signals from each locus.

(b) storing the item's genotype values and probability distribution on a computer database in a non-transitory memory;

With abundant single source DNA, there is usually no uncertainty about the genotype at a locus. The one or two tall data peaks that are present correspond to genotype alleles a and b, and definitively determine the item's genotype a,b allele pair at the locus. Thus, after having seen the STR data, the a,b genotype is assigned probability one, while all other allele pairs receive zero probability (Table 1, Posterior1).

The genotype of a single source item comprises a single allele pair (having probability one) at each genetic locus. The item's genotype is uploaded to a computer database that records the definite allele pair values at every locus. The genotypes on the database can arise from questioned evidence items (e.g., found at a crime scene) or from known reference items (e.g., taken from a person as a buccal swab). A database record can name a genotype with a (possibly anonymized) item identifier, and provides other relevant information, such as the owner, origin, forensic role, laboratory, time stamp, software version, how the sample was processed or how the data was interpreted.

(c) storing a population probability distribution on the computer database;

The alleles of a genetic locus have varying prevalence in a biological population, with some alleles more naturally abundant than others. This distribution can be measured by determining the genotypes of a convenience sample of (preferably at least a hundred) individuals, as described in steps a and b. Examining the alleles that comprise their genotypes forms a frequency distribution. Inputting these allele counts into a Dirichlet distribution forms an allele population distribution.

The genotype probability of a “random man” is a population probability distribution. The probability of a homozygote allele pair a,a is the square of a's allele probability. The probability of a heterozygote allele pair a,b is twice the product of the respective allele probabilities. This mathematically calculated distribution estimates the probability of observing a particular genotype value in the population. The computer database can store for every locus the allele probabilities, or the genotype probabilities, or both.

(d) specifying a match rule that defines a comparison between a first set of genotypes and a second set of genotypes stored on the database;

To compare evidence items with reference items on the database, a match rule can indicate that a set of Evidence genotypes should be compared with a set of Reference genotypes. Since a genotype database record may include identifiers or designate forensic roles (e.g., evidence, reference), retrieving genotype subsets based on such item information is straightforward.

(e) forming from the two sets of genotypes defined by the match rule, with a computer in communication with the database, pairs of genotypes that correspond to pairs of biological items;

In this example, there is a singleton set containing one Evidence item {evidence1}, and a second singleton set containing one Reference item {reference1}. In this example, the reference genotype is the same as the evidence genotype.

(f) partitioning the genotype pairs into disjoint groups that include all the pairs and do not overlap, ensuring that the number of pairs in each group remains bounded;

In this example, the partitioning is the singleton set containing the single (evidence1, reference1) genotype pair.

(g) calculating, with a computer in communication with the database, for each genotype pair in the disjoint group, a match statistic that uses the genotype probability distributions;

The likelihood ratio is a standard match statistic used for forensic identification purposes. At the locus we are considering in this example, the evidence and reference genotypes are equal, and so have the same allele pair a,b (Table 1, Allele Pair). The computer calculates the locus LR by multiplying the evidence genotype probability (Posterior1=1) by the reference genotype probability (Posterior2=1), and dividing by the population probability (Prior=0.04). This forms the product 1*1/0.04, which equals an LR of 25 for the locus.

The computer calculates the LR at the other loci in a similar way. Multiplying together the locus LR values as 25* . . . calculates the joint LR match statistic. In a preferred embodiment, logarithms of LRs are used, so that the joint log(LR) for the genotype pair is the sum of the locus log(LR) values. Multiplication can be done since STR are essentially independent of one another. When there are biological dependencies (as with the Y chromosome, and its Y-STR markers), other counting methods are used.

(h) storing on the database a pair of genotypes, together with a match statistic that quantifies a strength of association between the corresponding pair of biological items.

The pair of genotypes, evidence and reference, is stored on the database along with its joint LR or log(LR) value across all the assayed loci. The state of the database is updated with the new (evidence2, reference1) genotype pair to contain the match records:

| Evidence | Reference | Statistic |
|---|---|---|
| evidence1 | reference1 | 25 * . . . |

This pair can be retrieved later on by referring to the items, the strength of association indicated by the LR value, or genotypes attributes such as the case identifier.

When a large LR value (or, equivalently, a highly positive log(LR) value) is retrieved from the database, the numerical strength of association determines a potential match between the pair of biological items. Conversely, when a LR value much smaller than one (or, equivalently, a highly negative log(LR) value) is retrieved from the database, the numerical strength of association weighs against a match between the pair of biological items.

### 2. DNA Mixture Versus Reference

The invention's usefulness becomes apparent with genotypes that have uncertain probability distributions, where at some genetic loci the probability resides on more than one allele pair possibility. This situation commonly occurs with DNA mixtures.

DNA mixtures are commonly collected from scenes as biological items that include vaginal or penile swabs, clothing, bedding and dried secretions. DNA laboratories process these mixture items to obtain STR or other genetic data.

Claim 1, step (a) developing from genetic data a genotype for a biological item, together with a probability distribution over possible genotype allele pair values;

DNA evidence items often produce STR data that do not lead to definite genotypes. Instead, there is inherent genotype uncertainty that must be represented with probability. The posterior probability, determined after having analyzed the STR data, can be inferred using Bayesian computation.

Consider data at an STR locus where there are two short peaks at alleles ‘a’ and ‘b’, and a tall peak at allele ‘c’. The presence of three allele peaks suggests a mixture of at least two people, since one person typically has at most two different alleles. Suppose that the major contributor (e.g., a victim) to this two person mixture is known to have a c,c homozygote genotype. A computer examination of the data may conclude that the most likely explanation of the data is a minor contributor having genotype a,b (the two small peaks), but that there is also some likelihood that the minor contributor has a homozygote a,a or a heterozygote a,c genotype (Table 2, Likelihood).

Before seeing the data, it is known (in this example) that at this locus the allele probability distribution assigns 0.1 to ‘a’, 0.2 to ‘b’, 0.3 to ‘c’ and 0.4 to ‘d’. The prior genotype probability is then 0.01=(0.1)² for allele pair a,a, 0.04=2*0.1*0.2 for a,b, and 0.06=2*0.1*0.3 for a,c (Table 2, Prior).

By Bayes Theorem, the posterior probability is the product of the prior probability with the likelihood (Table 2, Prior*Like), renormalized by dividing by the product total (0.15 in this example) to equal one (Table 2, Posterior1). The evidence mixture genotype for the minor contributor at the locus is this Posterior1 probability distribution.

(b) storing the item's genotype values and probability distribution on a computer database in a non-transitory memory;

The genotype's values (Table 2, Allele Pair) and its probability distribution (Table 2, Posterior1) for every locus are uploaded to the computer database in the Evidence genotype section with the name evidence2.

(c) storing a population probability distribution on the computer database;

As in Example 1, the population probability distribution is present on the computer database. In another embodiment, the prior probabilities are uploaded and stored along with the uploaded genotype record.

(d) specifying a match rule that defines a comparison between a first set of genotypes and a second set of genotypes stored on the database;

As in Example 1, the match rule compares the Evidence genotype subset, now {evidence1, evidence2}, with the Reference genotype {reference1}.

(e) forming from the two sets of genotypes defined by the match rule, with a computer in communication with the database, pairs of genotypes that correspond to pairs of biological items;

The new pair of Evidence and Reference genotypes is (evidence2, reference1). Since the first pair (evidence1, reference1) has already been formed and evaluated, only the new second genotype pair (evidence2, reference1) needs to be formed.

(f) partitioning the genotype pairs into disjoint groups that include all the pairs and do not overlap, ensuring that the number of pairs in each group remains bounded;

The new genotype pairs comprise just the singleton set {(evidence2, reference1)}, which is clearly in a disjoint group bounded with just one element.

(g) calculating, with a computer in communication with the database, for each genotype pair in the disjoint group, a match statistic that uses the genotype probability distributions;

The LR at the locus is evaluated in Table 2 by multiplying the Posterior1 column for genotype evidence2 by the Posterior2 column for genotype reference1, dividing by the Prior column, and then adding up the terms in the LR column. For Allele Pair a,b, we see that mixture Posterior1 is 0.5333, reference Posterior2 is 1, while the Prior is 0.04. The product is 0.5333*1/0.04, or 13.33. Since all other terms in the LR column are zero, that one term for allele pair a,b gives the total LR at this one locus.

Across all the loci, the joint LR is 13.33* . . . . An uncertain genotype gives a match statistic that is less than or equal to the statistic of a matching definite genotype.

(h) storing on the database a pair of genotypes, together with a match statistic that quantifies a strength of association between the corresponding pair of biological items.

The state of the database has been updated with the new (evidence2, reference1) genotype pair to contain the match records:

| Evidence | Reference | Statistic |
|---|---|---|
| evidence1 | reference1 | 25 * . . . |
| evidence2 | reference1 | 13.33 * . . . |

Retrieving a numerically high strength of association, as illustrated here, would establish a potential match between the pair of evidence and reference items. This DNA link can provide an investigative lead in a cold case, connecting evidence at a crime scene with a convicted offender, who then may become a suspect in the crime.

### 3. Many DNA Mixtures Versus Many References

The invention's use of a database enables comparing many genotypes with many genotypes. A common application is comparing DNA evidence items with known reference samples.

Other commonly encountered DNA mixture items include weapons, condoms, bite marks and fingernails. These biological items are transformed by a crime lab's STR process into genetic data.

Claim 1, step (a) developing from genetic data a genotype for a biological item, together with a probability distribution over possible genotype allele pair values;

Genotypes can be developed from many (thousands, millions, or billions) evidence items. Similarly, genotypes can be developed from many (thousands, millions, or billions) reference items.

These genotypes are usually developed over time, and at any point only genotypes for new items need to be inferred, since the genotype for the old items have already been inferred. Here, reference2 has been developed as a new genotype (Table 3, Posterior2).

(b) storing the item's genotype values and probability distribution on a computer database in a non-transitory memory;

Genotypes developed from many evidence items can be uploaded to the Evidence part of the genotype database. Similarly, genotypes developed from many reference items can be uploaded to the Reference part of the genotype database.

Over time, only the newly developed genotypes need to be uploaded, since the database already has stored the old genotypes and their match comparison results. Here, genotype reference2 has been added to the Reference part of the database.

(c) storing a population probability distribution on the computer database;

The population probability distribution is present on the computer database, either as allele probabilities or genotype probabilities.

(d) specifying a match rule that defines a comparison between a first set of genotypes and a second set of genotypes stored on the database;

The match rule here continues to compare the Evidence genotype subset {evidence1, evidence2}, with the Reference genotype subset {reference1, reference2} to which genotype reference2 has been added.

(e) forming from the two sets of genotypes defined by the match rule, with a computer in communication with the database, pairs of genotypes that correspond to pairs of biological items;

Adding the new reference2 genotype to the Reference subset necessitates making comparisons with all the old Evidence genotypes, as indicated by the italicized rows in the table below.

| Evidence | Reference |
|---|---|
| evidence1 | reference1 |
| evidence2 | reference1 |
| evidence1 | reference2 |
| evidence2 | reference2 |

When comparing one set of objects of size M with another of size N, M*N comparisons and calculations have to be performed. Redoing the old operations requires a quadratic (e.g., when M=N) number of operations. However, databases can retrieve operations that have been previously done in the past in order to reuse the results.

Suppose that K new known genotypes are added to the Reference section. Then the number of comparison operations is M Evidence genotypes times (N+K) Reference genotypes, or M*(N+K) which equals M*N+M*K operations. The M*N old operations need not be repeated; only the M*K new operations have to be calculated incrementally. When the number K of new genotypes entering a database over time is small, the new operations require only a linear (e.g., a constant times M) number of operations.

(f) partitioning the genotype pairs into disjoint groups that include all the pairs and do not overlap, ensuring that the number of pairs in each group remains bounded;

Even with incremental update, where old match results are stored on the database and reused, the number of comparisons can grow large. For example, with a million genotypes on a database, adding ten more genotypes can initiate ten million new match comparison operations. Such computational requirements can overwhelm a database, whether as inner loops or input/output demands; when the computations blow up, match calculations may never be completed.

Bounding the computation into groups of manageable size remedies the situation. Suppose a database's memory and processors can easily handle a query for performing ten thousand pairs of genotype match comparisons and statistical calculations. Then dividing the ten million new match operations into a thousand groups of ten thousand operations each conquers the problem. These groups can be processed sequentially or in parallel by multiple computer processors. Regardless, partitioning the pairs into nonoverlapping groups whose union includes all genotype pairs provides a robust divide-and-conquer solution.

(g) calculating, with a computer in communication with the database, for each genotype pair in the disjoint group, a match statistic that uses the genotype probability distributions;

The old Evidence evidence1 and evidence2 genotypes are now compared with the new Reference reference2 genotype.

There is no overlap in the genotypes at the locus between evidence1 (whose value is a,b) and reference2 (whose value is a,a). Therefore, all LR terms are zero (Table 3a), and the total LR is 0. A zero or infinite LR is not meaningful, and so in real-world applications the LR is bounded away from zero, based on empirical studies that determine low probability behavior. For example, in genotyping applications the LR is rarely less than 0.01 at a locus, and so this value can be used as a lower bound.

Evidence genotype evidence2 and Reference genotype reference2 find their probability distribution support intersecting at allele pair a,a (Table 3b, Posterior1 and Posterior2), and so a nonzero LR can be calculated. Here the LR is 6.67, half of the 13.33 value seen in Example 2, because evidence2's likelihood at a,a is half that of a,b (Table 3b, Likelihood).

(h) storing on the database a pair of genotypes, together with a match statistic that quantifies a strength of association between the corresponding pair of biological items.

The database state is now updated with the new (evidence1, reference2) and (evidence2, reference2) genotype pairs so as to contain match records:

| Evidence | Reference | Statistic |
|---|---|---|
| evidence1 | reference1 | 25 * . . . |
| evidence2 | reference1 | 13.33 *. . . |
| evidence1 | reference2 | 0 * . . . |
| evidence2 | reference2 | 6.67 * . . . |

Some match statistics on the database provide a greater strength of association than others. Many, if not most, pairs of biological items on a large database will have negative log(LR) that suggests no statistical support for a match or support for an exclusion. These exclusions need not be retained on the database. That can reduce database memory space and retrieval time when determining potential matches between pairs of biological items.

### 4. DNA Mixtures Versus DNA Mixtures

The invention can compare evidence genotypes with evidence genotypes, even when both sets include uncertain genotypes. This example highlights steps b, d and g in claim 1.

Crime scenes can be connected through an individual who has contributed their DNA to evidence items at both scenes. These items may be DNA mixtures. In such cases, the individual's genotype may not be known with certainty, but statistical comparisons can be made on the evidence items through the genotype database. For example, a cigarette butt from a property crime can be linked with a condom wrapper from a sexual assault, providing DNA evidence for a person having been involved with both crimes. These mixture evidence items are collected from crime scenes, and run through a lab's STR analysis process to obtain genetic data.

(b) storing the item's genotype values and probability distribution on a computer database in a non-transitory memory;

Contributor genotypes from DNA mixtures are represented as probability distributions over allele pairs. The invention can store these probabilistic genotypes on the database.

(d) specifying a match rule that defines a comparison between a first set of genotypes and a second set of genotypes stored on the database;

In one embodiment, an evidence-to-evidence match rule is specified that compares evidence genotypes with evidence genotypes. This match rule can be useful in searching between cases and crime scenes, looking for evidence items that are associated through their biological genetic content. In this example, it compares Evidence genotypes with Evidence genotypes.

(g) calculating, with a computer in communication with the database, for each genotype pair in the disjoint group, a match statistic that uses the genotype probability distributions;

The invention can compare uncertain genotypes with each other, computing a LR match statistic that uses both genotype probability distributions. Table 4 shows the Evidence genotype probability distribution at a locus (Table 4, Posterior1) for item evidence1, and another Evidence genotype probability distribution (Table 4, Posterior2) for another mixture that divides its probability between allele pairs a,a and a,b. Both allele pairs provide support for an LR term:

Posterior1*Posterior2/Prior

0.0667*0.5/0.01=3.33

0.5333*0.5/0.04=6.67

Adding up the two terms gives a locus LR of 10 (Table 4, LR).

Retrieving strong associations from the database can connect pairs of evidence items that, in turn, connect two crime scenes. For example, a cigarette butt collected from a property crime can be statistically linked by the database with a condom wrapper collected from a rape, providing DNA evidence for a person common to both crimes. When a suspect is found for one crime, they become a suspect for both crimes.

### 5. DNA Mixtures Versus Kinship Genotypes

A kinship genotype is inferred from relatives, and is another type of uncertain genotype having a nontrivial probability distribution. The invention can store and match kinship genotypes. This example highlights steps a, b, d and g.

In mass disasters, victim remains need to be associated with missing people. Since a person is missing, their DNA cannot be collected directly for use as reference items. Instead, their personal effects (such sweaters, toothbrushes) can be collected from their home or office. Importantly, DNA can be collected from their family members, and converted by a DNA laboratory into genetic data.

(a) developing from genetic data a genotype for a biological item, together with a probability distribution over possible genotype allele pair values;

The genotype of an individual can be inferred from their relatives. By knowing the genotypes of one or more relatives, and the kinship pedigree structure, statistical methods can compute the individual's genotype as a probability distribution over allele pair values.

For example, if an individual of unknown genotype has a father and mother whose genotypes are both a,b, then by Mendel's laws the child's genotype is a,a with 25% probability, a,b with 50% probability and b,b with 25% probability.

(b) storing the item's genotype values and probability distribution on a computer database in a non-transitory memory;

The invention can store kinship-derived genotypes and their probability distributions genotypes on the database. This database approach finds application in disaster victim identification (DVI), where victim remains are compared with genotypes of missing persons derived from the DNA of their relatives in order to identify the victim remains.

The invention can also be used to build familial searching databases, where the Reference genotypes have probability distributions of family members that are derived from criminal offenders. These databases can provide investigative leads to locate relatives of perpetrators based on DNA evidence left at a crime scene.

(d) specifying a match rule that defines a comparison between a first set of genotypes and a second set of genotypes stored on the database;

In this embodiment, it is useful to specify a match rule where one of the genotype sets is comprised of Kinship genotypes. The other genotype set may be for Evidence or Reference items, depending on the identification application.

(g) calculating, with a computer in communication with the database, for each genotype pair in the disjoint group, a match statistic that uses the genotype probability distributions;

Table 5 shows an Evidence mixture genotype probability distribution (Table 5, Posterior1) and a Kinship genotype probability distribution (Table 5, Posterior2) at one locus, as they are compared on a database. The match statistic uses the genotype probability distributions to determine a strength of association. The nonzero LR terms are calculated as:

Posterior1*Posterior2/Prior

0.0667*0.25/0.01=1.67

0.5333*0.50/0.04=6.67

Summing the two terms gives a LR of 8.33 at the locus (Table 5, LR).

Retrieving a sufficiently high LR gives a strength of association that indicates a potential match between the pair of biological items. In DVI applications, this database pairing identifies human remains by associating them with a missing person.

### Tables

TABLE 1

| Allele Pair | Prior | Posterior1 | Posterior2 | LR |
|---|---|---|---|---|
| a, b | 0.04 | 1 | 1 | 25 |

TABLE 2

| Allele | | | | | | |
|---|---|---|---|---|---|---|
| Pair | Prior | Likelihood | Prior*Like | Posterior1 | Posterior2 | LR |
| a, a | 0.01 | 1 | 0.01 | 0.0667 | | |
| a, b | 0.04 | 2 | 0.08 | 0.5333 | 1 | 13.33 |
| a, c | 0.06 | 1 | 0.06 | 0.4000 | | |
| | | | 0.15 | 1.0000 | | 13.33 |

TABLE 3a

| Allele Pair | Posterior1 | Posterior2 | LR |
|---|---|---|---|
| a, a | | 1 | |
| a, b | 1 | | |
| | | | 0 |

TABLE 3b

| Allele | | | | | | |
|---|---|---|---|---|---|---|
| Pair | Prior | Likelihood | Prior*Like | Posterior1 | Posterior2 | LR |
| a, a | 0.01 | 1 | 0.01 | 0.0667 | 1 | 6.67 |
| a, b | 0.04 | 2 | 0.08 | 0.5333 | | |
| a, c | 0.06 | 1 | 0.06 | 0.4000 | | |
| | | | 0.15 | 1.0000 | | 6.67 |

TABLE 4

| Allele | | | | | | |
|---|---|---|---|---|---|---|
| Pair | Prior | Likelihood | Prior*Like | Posterior1 | Posterior2 | LR |
| a, a | 0.01 | 1 | 0.01 | 0.0667 | 0.5 | 3.33 |
| a, b | 0.04 | 2 | 0.08 | 0.5333 | 0.5 | 6.67 |
| a, c | 0.06 | 1 | 0.06 | 0.4000 | | |
| | | | 0.15 | 1.0000 | 1.0 | 10.00 |

TABLE 5

| Allele | | | | | | |
|---|---|---|---|---|---|---|
| Pair | Prior | Likelihood | Prior*Like | Posterior1 | Posterior2 | LR |
| a, a | 0.01 | 1 | 0.01 | 0.0667 | 0.25 | 1.67 |
| a, b | 0.04 | 2 | 0.08 | 0.5333 | 0.50 | 6.67 |
| a, c | 0.06 | 1 | 0.06 | 0.4000 | | |
| b, b | 0.04 | | | | 0.25 | |
| | | | 0.15 | 1.0000 | 1.00 | 8.33 |

### REFERENCES

The following citations have been referred to in this specification, and are incorporated by reference into the specification.
Aitken, C. G. and F. Taroni (2004). Statistics and the Evaluation of Evidence for Forensic Scientists. Chicester, UK, John Wiley & Sons.
Bieber, F. R., C. H. Brenner and D. Lazer (2006). “Finding criminals through DNA of their relatives.” Science 312(5778): 1315-1316.
Butler, J. M. (2005). Forensic DNA Typing: Biology, Technology, and Genetics of STR Markers. New York, Academic Press.
Date, C. J. (2004). An introduction to database systems. Boston, Addison-Wesley.
Forgy, C. L. (1982). “Rete: A Fast Algorithm for the Many Pattern/Many Object Pattern Match Problem.” Artificial Intell. 19(1): 17-37.
Gelman, A., J. B. Carlin, H. S. Stern and D. Rubin (1995). Bayesian Data Analysis. Boca Raton, Fla., Chapman & Hall/CRC.
Good, I. J. (1950). Probability and the Weighing of Evidence. London, Griffin.
MacKay, D. J. (2003). Information Theory, Inference and Learning Algorithms. Cambridge, UK, Cambridge University Press.
Perlin, M. W. (2007). Identifying human remains using TrueAllele® technology. Forensic Investigation and Management of Mass Disasters. M. I. Okoye and C. H. Wecht. Tucson, Ariz., Lawyers & Judges Publishing Co: 31-38.
Perlin, M. W. and A. Sinelnikov (2009). “An information gap in DNA evidence interpretation.” PLoS ONE 4(12): e8327.
Perlin, M. W. (2010). Explaining the likelihood ratio in DNA mixture interpretation. Promega's Twenty First International Symposium on Human Identification. San Antonio, Tex.
Perlin, M. W., M. M. Legler, C. E. Spencer, J. L. Smith, W. P. Allan, J. L. Belrose and B. W. Duceman (2011). “Validating TrueAllele® DNA mixture interpretation.” J Forensic Sci 56(6): 1430-1447.
Perlin, M. W., J. L. Belrose and B. W. Duceman (2013). “New York State TrueAllele® Casework validation study.” J Forensic Sci 58(6): 1458-1466.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A method for matching biological items using a database, comprising the steps of:
(a) developing from genetic data a genotype for a biological item, together with a probability distribution over possible genotype allele pair values;
(b) storing the item's genotype values and probability distribution on a computer database in a non-transitory memory;
(c) storing a population probability distribution on the computer database;
(d) specifying a match rule that defines a comparison between a first set of genotypes and a second set of genotypes stored on the database;
(e) forming from the two sets of genotypes defined by the match rule, with a computer in communication with the database, pairs of genotypes that correspond to pairs of biological items;
(f) partitioning the genotype pairs into disjoint groups that include all the pairs and do not overlap, ensuring that the number of pairs in each group remains bounded;
(g) calculating, with a computer in communication with the database, for each genotype pair in the disjoint group, a match statistic that uses the genotype probability distributions; and
(h) storing on the database a pair of genotypes, together with a match statistic that quantifies a strength of association between the corresponding pair of biological items.

2. A method for matching objects using a database, comprising the steps of:
(a) developing from observable data an identitype for an object, where the identitype represents an attribute of the object together with a probability distribution over possible values for the attribute;
(b) storing the object's identitype values and probability distribution on a computer database in a non-transitory memory;
(c) storing a population probability distribution on the computer database;
(d) specifying a match rule that defines a comparison between a first set of identitypes and a second set of identitypes stored on the database;
(e) forming from the two sets of identitypes defined by the match rule, with a computer in communication with the database, pairs of identitypes that correspond to pairs of objects;
(f) partitioning the pairs of identitypes into disjoint groups that include all the pairs and do not overlap, ensuring that the number of pairs in each group remains bounded;
(g) calculating for each identitype pair in the disjoint group, with a computer in communication with the database, a likelihood ratio as a sum over products, where at each attribute value, a term multiplies the two identitype probabilities and divides by the population probability; and
(h) storing on the database a pair of identitypes, together with its likelihood ratio that quantifies a strength of association between the corresponding pair of objects.

3. An apparatus for matching biological items comprising:
a computer database in a non-transitory memory which stores a genotype for a biological item together with a probability distribution over possible genotype allele pair values with respect to the genotype, a population probability distribution and a match rule that defines a comparison between a first set of genotypes and a second set of genotypes stored on the database; and
a computer in communication with the database which forms from the first and second sets of genotypes defined by the match rule pairs of genotypes that correspond to pairs of biological items, partitions the genotype pairs into disjoint groups that include all the pairs, where the groups do not overlap, ensuring that the number of pairs in each group remains bounded, calculates for each genotype pair in the disjoint group a match statistic that uses the genotype probability distributions, and stores on the database a pair of genotypes, together with its match statistic that quantifies a strength of association between the corresponding pair of biological items.

4. A method as described in claim 1, where in the calculating step (g) the match statistic is a likelihood ratio.

5. A method as described in claim 4, where the likelihood ratio is calculated as a sum over products, where at each allele pair, a term multiplies the two genotype probabilities and divides by a genotype population probability.

6. A method as described in claim 1, where before the developing step (a) there is the step of collecting the biological item and obtaining genetic data from the item.

7. A method as described in claim 1, where after the storing step (h) there is the step of retrieving from the database the strength of association to determine a potential match between the pair of biological items.

8. A method as described in claim 1, where a biological item is a mixture.

9. A method as described in claim 7, where the potential match relates a first crime scene to a second crime scene.

10. A method as described in claim 1, where the calculating in step (g) is done in an incremental manner, without recalculating match statistics for previously examined genotype pairs.

11. A method as described in claim 1, where the calculating in step (g) is initiated through a structured query on a relational database.

12. A method as described in claim 1, where the storing in step (h) saves computer memory space by only retaining genotype pairs whose match statistic exceeds a predetermined numerical value.

13. A method as described in claim 1, where the calculating in step (g) is done by a computer database.

14. A method as described in claim 11, where the structured query is dynamically formed from a query clause that is stored on the database.

13. A method as described in claim 1, where in step (g) the calculating is done by a plurality of computer processors.

14. A method as described in claim 7, where the retrieving step is done based on user preferences about features of the potential matches.

15. A method as described in claim 7, where the retrieving step is done after the computer notifies an interested user about a match result.

16. A method as described in claim 1, where a biological item is related to remains of a victim.

17. A method as described in claim 1, where a biological item is related to a missing person.

18. A method as described in claim 6, where the biological item is collected from a crime scene.

19. A method as described in claim 6, where the biological item is collected from an individual who has been previously convicted of a crime.

20. A method as described in claim 1, where the match rule in step (d) compares a first set of evidence genotypes with a second set of reference genotypes.
